(19) United States
(12) Patent Application Publication
(10) Pub. No.: US 2014/0015786 A1
(43) Pub. Date: Jan. 16, 2014

(54) ELECTRONIC DEVICE

(71) Applicant: Hiroaki Honda, Yokohama-shi (JP)

(72) Inventor: Hiroaki Honda, Yokohama-shi (JP)

(73) Assignee: KYOCERA CORPORATION, Kyoto-shi, Kyoto (JP)

(21) Appl. No.: 14/007,957

(22) PCT Filed: Mar. 28, 2012
(86) PCT No.: PCT/JP2012/058227

§ 371 Date: Sep. 26, 2013

(30) Foreign Application Priority Data
Mar. 29, 2011 (JP) 2011-072765

(51) Int. Cl. G06F 3/041; G06F 3/0481

(52) U.S. Cl. CPC G06F 3/0412; G06F 3/04817
USPC 345/173

(57) ABSTRACT

An electronic device according to the present invention includes a display module, a touch panel, and a control module configured to control display of the display module in accordance with an operation to the touch panel. The display module displays an image to cause the electronic device to execute predetermined processing, and the control module transfers the image in accordance with the operation to the touch panel. When a predetermined operation is executed during the operation to the touch panel of transferring the image, the control module cancels the transfer of the image and causes the display module to display the image at a position before the transfer.

### TECHNICAL FIELD

The present invention relates to an electronic device in which operating a touch panel enables an arrangement position of an icon to be changed.

### BACKGROUND ART

In recent years, in a portable communication field, a portable terminal called a smartphone has been widespread. The smartphone has a communication function through a public telephone network or wireless LAN, a transmission/reception function of electronic mails, a connection function to the Internet, a shooting/reproduction function of still images and moving images, a creation/editing function of document files, various accessory functions (e.g., a calendar and a calculator), and the like.

Furthermore, the smartphone is configured so as to be able to add a new function by downloading an application (software) through the Internet or the like. In the smartphone, a touch panel is provided on a display surface of a display module, and employing a graphical user interface (GUI) allows operation and input corresponding to the above-described diversified functions to be implemented.

In a general smartphone, a desktop screen is displayed as a main operation screen. Normally, in the desktop screen, in addition to a status bar indicating an operation status of the smartphone, icons corresponding to applications related to the above-described functions, and icons corresponding to downloaded applications are included. In order to enable a user to easily use an application selected from many applications, the smartphone is configured so that a plurality of desktop screens are switched and displayed, and the user can freely set and edit types, positions and the like of the icons included in the respective desktop screens.

When the position of the icon is changed on the desktop screen, drag operation is performed with the object icon as a stating point, and drop operation is performed at a desired vacant position. When the drag operation is performed to a right end or a left end of the screen, the desktop screen displayed on the display module is switched. When the icon is transferred from the displayed desktop screen to another desktop screen, the user needs to operate the touch panel until the desktop screen considered to be proper as a transfer destination of the icon is displayed.

In the general smartphone, a menu screen is displayed in place of the desktop screen. The menu screen shows a table of the applications that the smartphone can execute, and each of the applications is displayed as the icon. Since many icons are included, the displayed icons are replaced by means of a scroll bar and flick operation on the general menu screen. A shortcut icon of the icon (i.e., the application) included in the menu screen is created to be arranged on the desired desktop screen, by which the icon is added to the desktop screen.

Although the user performs drag operation to transfer the icon to a position on one of the desktop screens, the user may change his or her mind. For example, although the icon is transferred from one of the desktop screens to a different desktop screen, if the relevant icon has a tenuous connection with the icons already included in the desktop screen of the transfer destination, the user may think that it is preferable to cancel the transfer of the icon and return the icon to the original position on the original desktop screen.

In a conventional smartphone, in order to cancel the transfer of the icon, the icon needs to be returned by the drag operation on the touch panel to the original position on the desktop screen. However, in the above-described drag operation, when the transfer of the icon across many desktop screens is cancelled, the user needs to perform the drag operation to transfer the icon to an end of the screen, and to continue switching of the screens until the original desktop screen is displayed, for example, which is very troublesome. Since in recent years, as to the smartphone, the desktop screens that can be switched and displayed have a tendency toward increase in number, this work will be more troublesome.

Thus, in an electronic device equipped with a touch panel, enhancement in operability of transfer of an image such as an icon and the like is desired.

### SUMMARY OF THE INVENTION

An electronic device according to one aspect of the present invention is an electronic device comprising:

a display module;

a touch panel provided on a display surface of the display module; and

a control module configured to control display of the display module, wherein

the display module displays an image to cause the electronic device to execute predetermined processing, and the control module transfers the image in accordance with an operation to the touch panel, and

when a predetermined operation is executed during the operation to the touch panel of transferring the image, the control module cancels the transfer of the image and causes the display module to display the image at a position before the transfer.

### BRIEF DESCRIPTION OF THE DRAWINGS

FIG. 1 is a block diagram showing an outline of a smartphone according to one embodiment of the present invention.

FIG. 2 is a front view of the smartphone according to the one embodiment of the present invention, showing a state where a desktop screen is displayed.

FIG. 3 is a flowchart showing a first aspect of transfer processing of an icon according to the one embodiment of the present invention.

FIG. 4 is a front view of the smartphone according to the one embodiment of the present invention, showing how an icon is specified.

FIG. 5 is a front view of the smartphone according to the one embodiment of the present invention, showing how drag operation is performed.

FIG. 6 is a front view of the smartphone according to the one embodiment of the present invention, showing how the desktop screen is switched.

FIG. 7 is a front view of the smartphone according to the one embodiment of the present invention, showing how the drag operation is performed.

FIG. 8 is a front view of the smartphone according to the one embodiment of the present invention, showing how flick operation is performed.

FIG. 9 is a front view of the smartphone according to the one embodiment of the present invention, showing a state where the desktop screen is displayed.

FIG. 10 is a flowchart showing a second aspect of the transfer processing of the icon according to the one embodiment of the present invention.

FIG. 11 is a front view of the smartphone according to the one embodiment of the present invention, showing a state where a menu screen is displayed.

FIG. 12 is a flowchart showing a first aspect of setting processing of a shortcut icon according to the one embodiment of the present invention.

FIG. 13 is a front view of the smartphone according to the one embodiment of the present invention, showing a state where the shortcut icon is created.

FIG. 14 is a front view of the smartphone according to the one embodiment of the present invention, showing how flick operation is performed.

FIG. 15 is a flowchart showing a second aspect of the setting processing of the shortcut icon according to the one embodiment of the present invention.

FIG. 16 is a flowchart showing a third aspect of the setting processing of the shortcut icon according to the one embodiment of the present invention.

FIG. 17 is a front view of the smartphone according to the one embodiment of the present invention, showing how an image notifying that cancel is enabled is displayed.

### DETAILED DESCRIPTION OF EMBODIMENTS

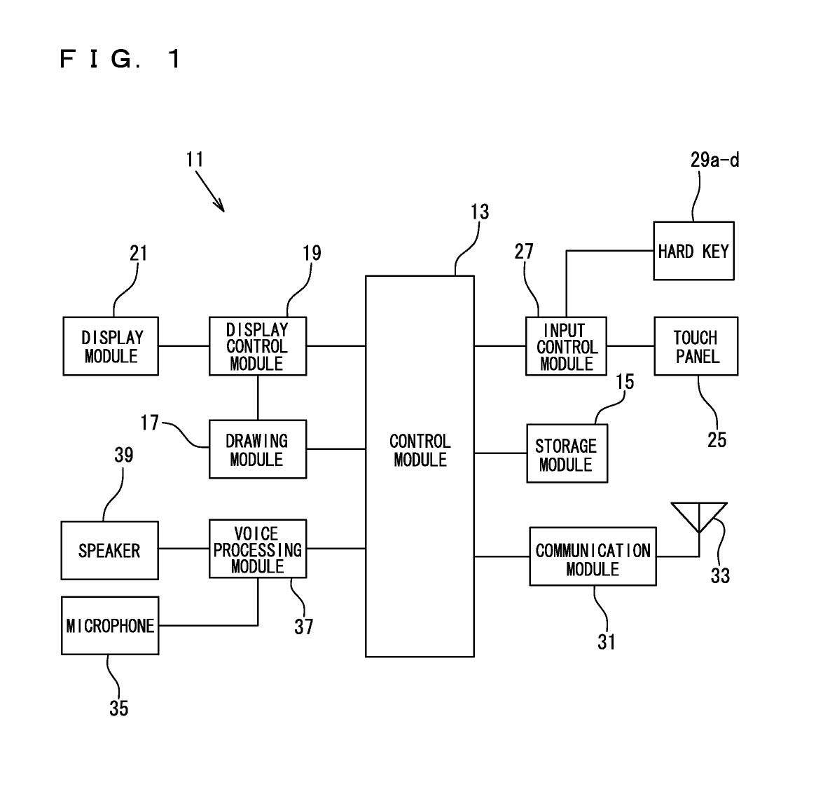

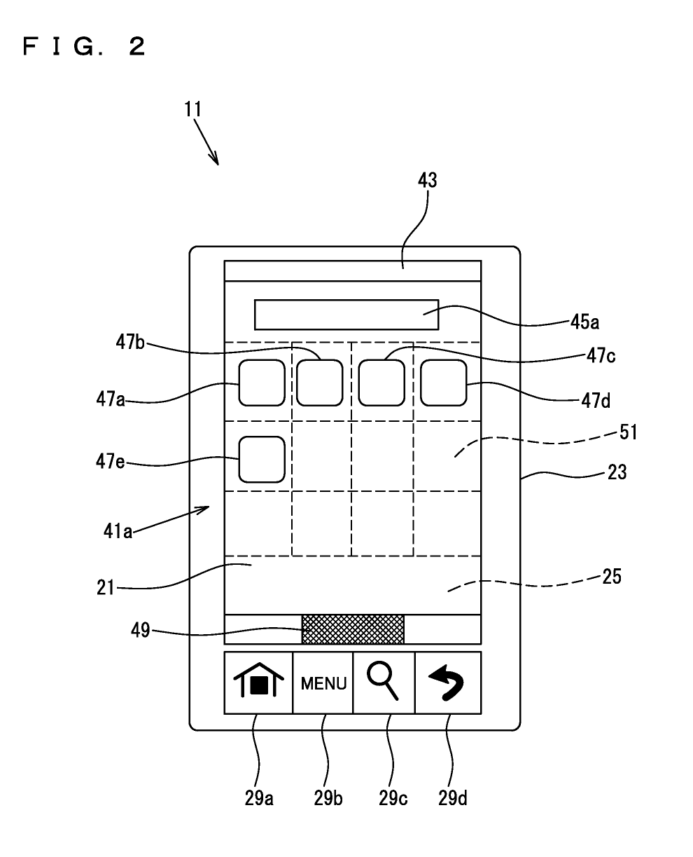

Hereinafter, one embodiment of the present invention will be described in detail with reference to the drawings. FIG. 1 is a block diagram showing an outline of a smartphone 11, which is one example of an electronic device according to one embodiment of the present invention. FIG. 2 is a front view of the smartphone 11.

A control module 13 configuring a control module according to one example of the present invention includes a CPU (not shown) that performs various types of arithmetic operation processing, and panoptically executes control of the smartphone 11. A storage module 15 configuring a storage module according to one example of the present invention includes a ROM, a RAM, a flash memory and the like (none of which is shown), and in the ROM, various programs that describe control procedures to be executed by the control module 13, and the like are stored, and in the RAM, data processed in the CPU of the control module 13 and the like are temporarily stored. In the flash memory, data of components of the various applications and screens (e.g., data of icons, buttons and background) and the like are stored. The control module 13 and the storage module 15 function as a computer in the smartphone 11.

A drawing module 17 synthesizes the data of the components of each of the screens stored in the storage module 15 to generate screen data, based on an instruction of the main control module 13. The generated screen data is stored in a VRAM of a display control module 19. The display control module 19 displays the screen on a display module 21 configuring a display module according to one example of the present invention, based on the screen data stored in the VRAM. The display module 21 is, for example, a liquid crystal display device, and is housed in a housing 23 so as to be visible from an opening provided on a front surface of the housing 23, as shown in FIG. 1.

The smartphone 11 includes a touch panel 25 and hard keys (29a to 29d) as an input or operation module. The touch panel 25 is, for example, an electrostatic capacitance type touch panel, and is overlapped on a display surface of the display module 21 so as to close the opening of the housing 23. When the touch panel 25 is touched by a user, an analog signal in accordance with a touch position is outputted to an input control module 27. The input control module 27 processes the analog signal transmitted from the touch panel 25, and transmits a touch position signal indicating the touch position on the touch panel 25 to the control module 13.

In FIG. 2, the four hard keys 29a to 29d provided on the front surface of the housing 23, that is, a home key 29a, a menu key 29b, a search key 29c and a back key 29d are shown. The home key 29a is used, for example, to display a desktop screen on the display module 21. The menu key 29b is used, for example, to display a submenu on the display module 21 at the time of execution of the application. The search key 29c is used, for example, to display a search screen for use in search through the internet. The back key 29d is used to return the display screen of the display module 21 to the last display screen or the previous display screen. When one of the four hard keys 29a to 29d is pressed or when a hard key whose illustration is omitted (e.g., a power key) is pressed, the input control module 27 transmits a signal indicating the pressing to the control module 13.

A communication module 31 is connected to an antenna 33, and performs processing necessary for communication between the smartphone 11 and a base station of a public telephone network or an access point of wireless LAN (e.g., modulation/demodulation processing of transmitted/received data), based on an instruction transmitted from the control module 13.

A microphone 35, for example, converts voice of the user to an analog voice signal to transmit the same to a voice processing module 37. The voice processing module 37 digitalizes the voice signal transmitted from the microphone 35 to transmit the signal to the control module 13. Moreover, the voice processing module 37 analogizes the digital voice signal transmitted from the control module 13 to transmit the signal to a speaker 39.

In the smartphone 11, a plurality of desktop screens can be set, and one of these desktop screens is displayed on the display module 21. In the smartphone 11 of the present example, the five desktop screens can be set or can be displayed, for example, and as in a general smartphone, these desktop screens are composed of a central desktop screen and two desktop screens arranged on both sides thereof. At the start time of the smartphone 11, the central desktop screen is displayed, for example. In FIG. 2, how a central desktop screen 41a is displayed on the display module 21 of the smartphone 11 is shown. Rightward or leftward flick operation on the touch panel 25 switches the desktop screen 41a to another desktop screen resulting from scroll transfer from the right side or the left side. The flick operation is an operation of touching and sweeping the touch panel 25 rapidly with a finger, a pen or the like.

In the illustrated desktop screen 41a, a status bar 43, a widget 45a, icons 47a to 47e and a launcher 49 are included. The status bar 43 is arranged in an uppermost portion of the desktop screen 41a, and information regarding a status of the smartphone 11, for example, information regarding a communication status and a battery level is displayed. Moreover, when the touch panel 25 is drag-operated downward from the status bar 43 as a starting point, a table of items that the smartphone 11 is currently processing or the like is displayed on the display module 21. The drag operation is an operation of moving the touch position while touching the touch panel 25. The status bar 43 is arranged on all the desktop screens. The widget 45a is a text box, a window or the like related to a specific application.

On the illustrated desktop screen 41a, the five icons 47a to 47e are arranged. Each of these icons 47a to 47e is an image to cause the smartphone 11 to execute predetermined processing, and expresses a specific application. When the touch panel 25 is tapped (touched or contacted for a short time) on each of the icons 47a to 47e, the control module 13 executes the application or a command corresponding to the relevant icon (47a to 47e). A maximum number of the icons that can be arranged on one of the desktop screens varies in accordance with presence or absence of the widget and the like.

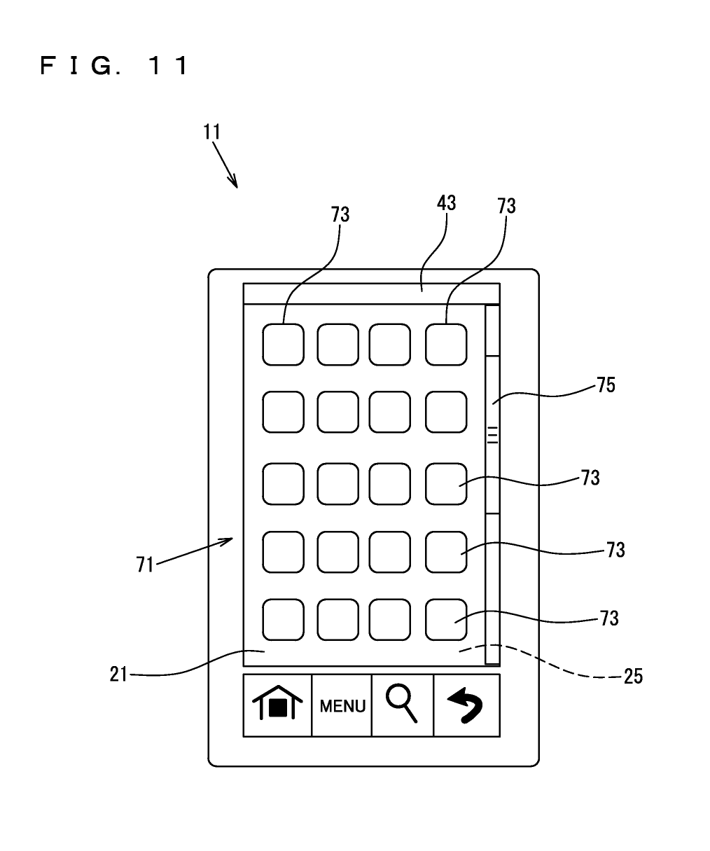

In a lowermost portion of the illustrated desktop screen 41a, the launcher 49 is arranged. The launcher 49 is arranged on all the desktop screens. When the touch panel 25 is tapped on the launcher 49, a menu screen 71 shown in FIG. 11 is displayed on the display module 21. The menu screen 71 will be described later.

In the flash memory of the storage module 15, setting information of each of the plurality of desktop screens is stored. The setting information includes the numbers, types, positions and the like of the widgets and the icons included in each of the desktop screens. In each of the plurality of desktop screens, at least one of the icons can be arranged. Moreover, the desktop screen not including any widget and any icon can be set.

On each of the desktop screens, rectangular icon arrangement zones 51 as indicated by wavy lines in FIG. 2 are set in a grid shape, and each of the icons is contained inside each of the icon arrangement zones 51. The user can transfer the icons on each of the plurality of desktop screens. Specifically, the drag operation on the touch panel 25 is performed to the icon to be transferred as a starting point, by which the icon is transferred so as to put the center thereof in the vacant icon arrangement zone 51, and drop operation is performed. Thereby, the icon is arranged so as to be contained in the icon arrangement zones 51. Furthermore, the user can also transfer the icon included in one of the desktop screens to a vacant position on another desktop screen. The drop operation is an operation of releasing a touch or contact state to the touch panel 25.

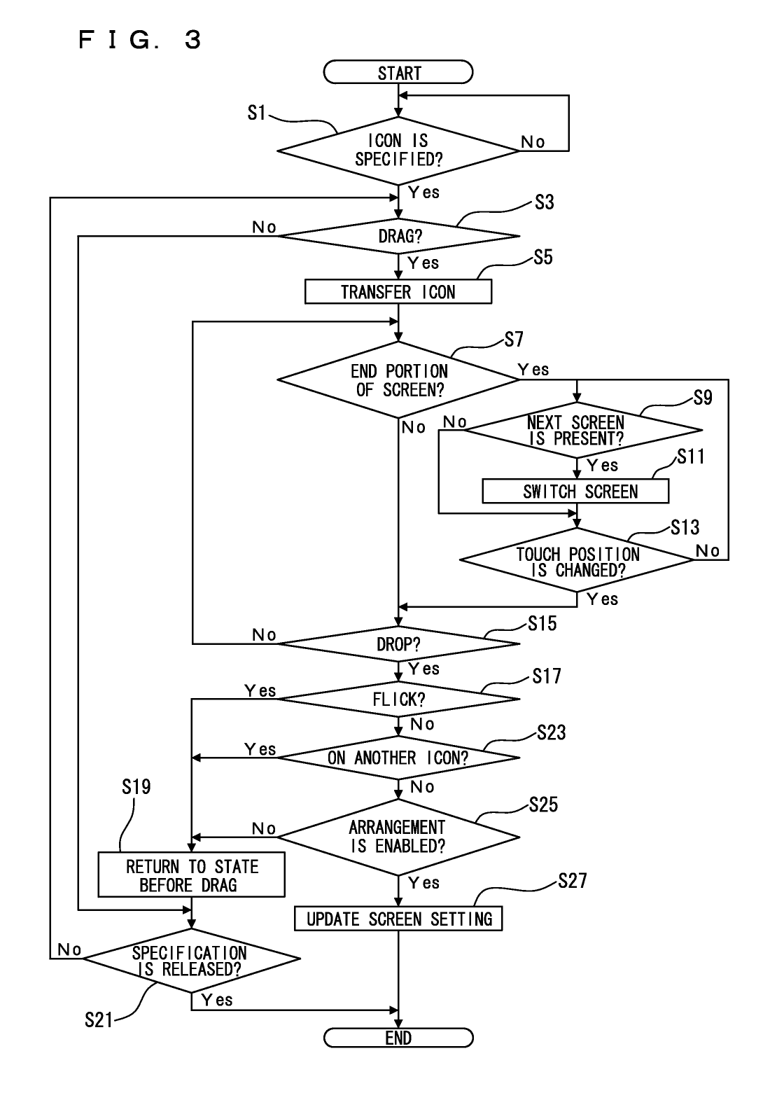

FIG. 3 is a flowchart showing transfer processing of the icon on the desktop screen or between the desktop screens, according to one example of the present invention. A program describing a procedure of this processing is stored in the ROM of the storage module 15, and is executed by the control module 13. First, the control module 13 determines whether or not the specific icon of the desktop screen currently displayed on the display module 21 is specified as an object of the transfer processing (S1). The specification of the icon is performed by long press (long touch) of the touch panel 25 on the icon. Specifically, the control module 13 determines whether or not the touch panel 25 is long-pressed on the specific icon, based on a touch position signal indicating the touch position on the touch panel 25, the touch position signal being transmitted from the input control module 27, and duration thereof.

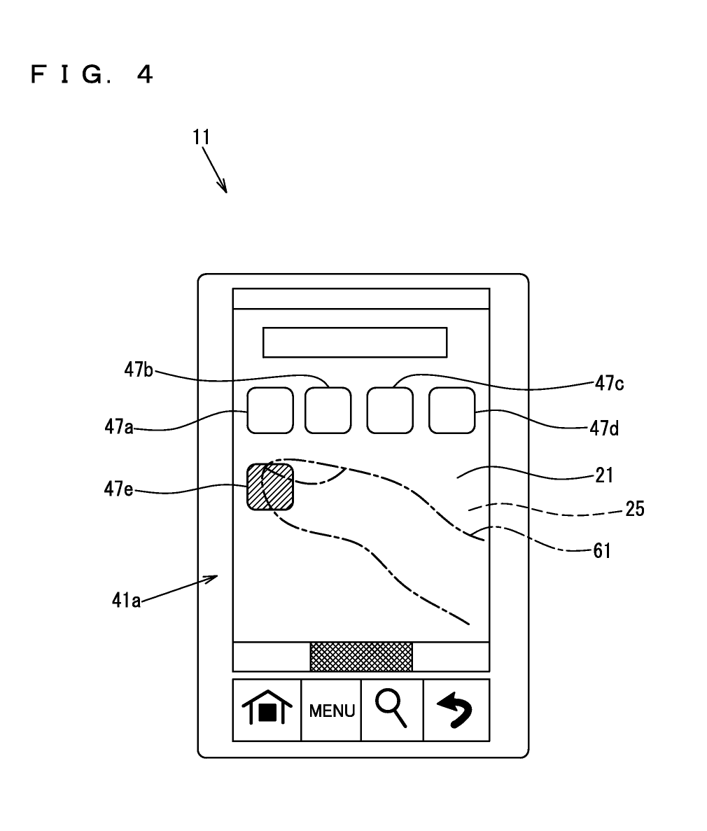

FIG. 4 shows how a finger 61 of the user long-presses the touch panel 25 on the icon 47e on the desktop screen 41a illustrated in FIG. 3, by which the icon 47e is specified as the transfer object. The specified icon 47e is highlighted, for example, by vibrating, blinking or the like to be thereby visually distinguished from the other icons 47a to 47d displayed on the desktop screen 41a.

If the control module 13 determines that the icon of the transfer object has been specified by the user, the control module 13 determines whether or not the drag operation has been performed to the icon of the transfer object as a starting point, based on the touch position signal transmitted from the input control module 27 (S3). If the drag operation has been performed, the control module 13 gives an instruction to the drawing module 17, and changes the screen data of the desktop screen so as to display the icon at a position corresponding to the touch position. This allows the icon to be transferred on the display screen, that is, on the desktop screen with the drag operation (S5).

After step S5, the control module 13 determines whether or not the touch position on the touch panel 25 has reached a right end or a left end of the desktop screen, based on the touch position signal transmitted from the input control module 27 (S7). If in step S5, the control module 13 determines that the touch position has reached the right end or the left end of the screen, the control module 13 determines whether or not the next desktop screen to be switched and displayed is present (S9). If the next desktop screen is present, the control module 13 instructs the drawing module 17 to change image data of the desktop screen to the screen data of the next desktop screen, so that the desktop screen displayed on the display module 21 is switched (S11). On the desktop screen after the switching, the icon of the transfer processing object is arranged at the same position as that before the switching.

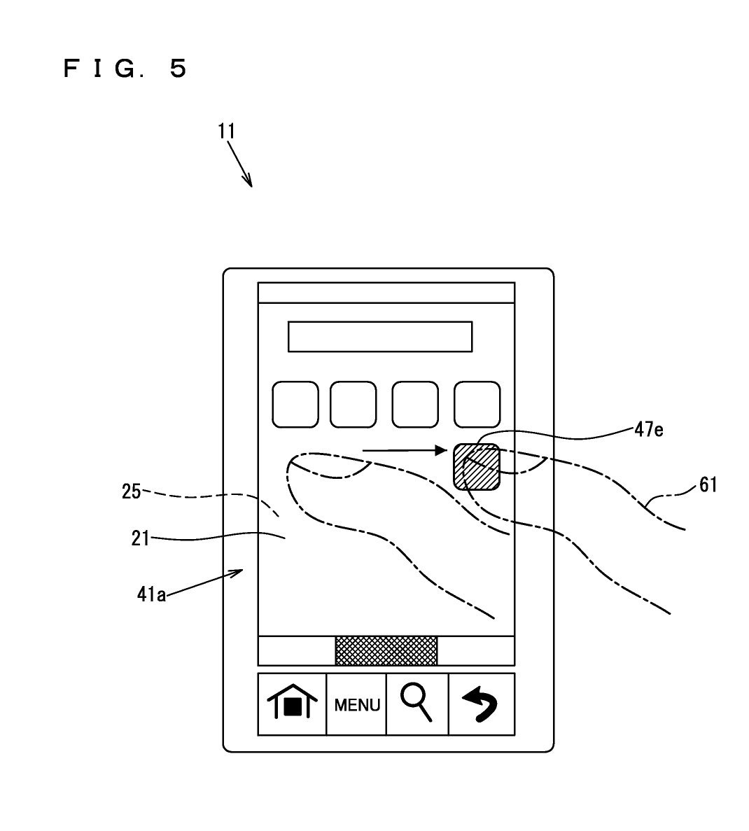

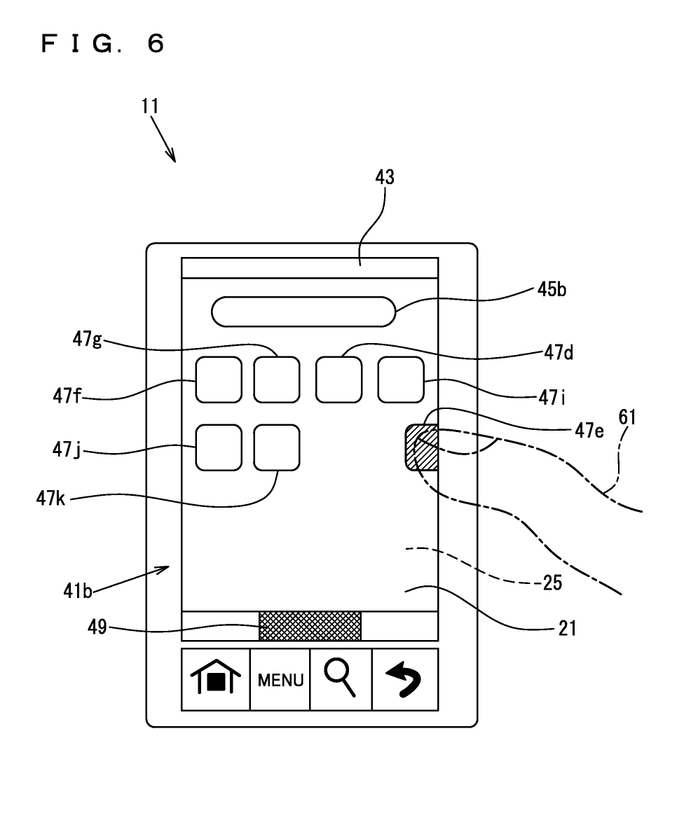

FIG. 5 shows how the user performs the rightward drag operation from the state shown in FIG. 4. The icon 47e is transferred under the finger 61 of the user performing the drag operation. FIG. 6 shows how the touch position of the finger 61 of the user reaches the right end of the desktop screen 41a, where steps S9 and S11 are executed, and the desktop screen 41b on the right side of the central desktop screen 41a is displayed on the display module 21. In the desktop screen 41b, the status bar 43, a widget 45b, icons 47f to 47g and the launcher 49 are included.

The control module 13 determines whether or not the touch position has been changed from the end portion within a predetermined time after the desktop screen is switched in step S11 (S13). If it is not determined that the touch position has been changed, the control module 13 re-executes step S9. For example, in the present example, the two desktop screens exist on each of both sides of the central desktop screen 41a, and when step S11 is further executed from the state shown in FIG. 6, the rightmost desktop screen is displayed on the display module 21. In the case where thereafter, step S13 and also step S9 are executed, it is determined in step S9 that the next screen is absent. When it is determined in step S9 that the next screen is absent, step S13 is executed.

If in step S7, it is not determined that the touch position has reached a right end or a left end of the desktop screen, or if in step S13, it is determined that the touch position has been changed from the end portion (the change determined in step S13 includes one by the drop operation), the control module 13 determines whether or not the drop operation has been performed by the user (S15). When the transmission of the touch position signal from the input control module 27 stops (or when the touch position signal indicates that the touch panel 25 is not touched), the control module 13 determines that the drop operation has been performed by the user.

If it is determined that the drop operation has been performed, the control module 13 determines whether or not flick operation has been performed by the user (i.e., whether or not the drop operation determined in step S15 has accompanied the flick operation), based on the touch position signal transmitted from the input control module 27 (S17). For example, if a time required for moving the touch position by a predetermined distance (e.g., 50 pixels) is within a predetermined value (e.g., 50 msec.), the control module 13 determines that the flick operation has been performed by the user. In the flick operation, the icon transfers at a predetermined speed or higher.

In place of the flick operation, an operation of inhibiting the image from being transferred from a predetermined area for a predetermined time may be employed. Specifically, there can be exemplified an operation in which long press inhibits the image from being transferred from the same position for the predetermined time, and the operation in which for the predetermined time, the image is transferred to Recycle Bin or a predetermined deletion area of the icons or the like displayed on the display module 21.

If in step S17, it is determined that the predetermined operation, that is, in the present example, the flick operation has been performed, the control module 13 instructs the drawing module 17 to return the screen displayed on the display module 21 to the state where the icon of the transfer object is selected in step S1, that is, the state before the step S5 is executed by the drag operation (S19). That is, the flick operation cancels (or stops) the transfer of the icon. After step S19, the control module 13 determines whether or not the specification of the icon specified in step S1 has been released (S21). For example, when the touch panel 25 is long-pressed on the specified icon, the specification is released. If it is not determined that the specification has been released, step S3 and subsequent steps are again performed. If in step S21, it is determined that the specification of the icon has been released, the control module 13 ends the transfer processing of the icon. If in step S3, it is not determined that the drag operation has been performed, step S21 is also executed.

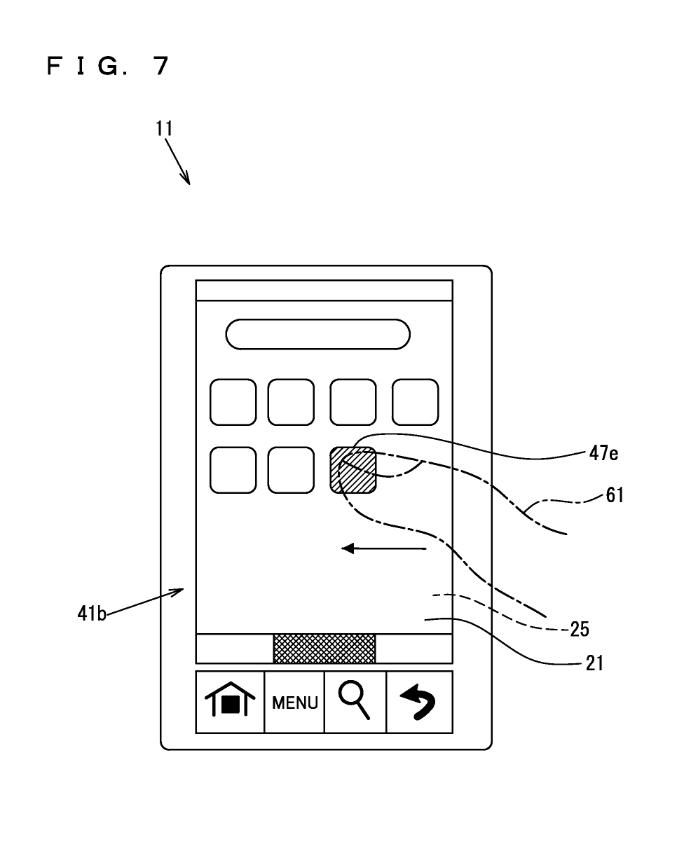

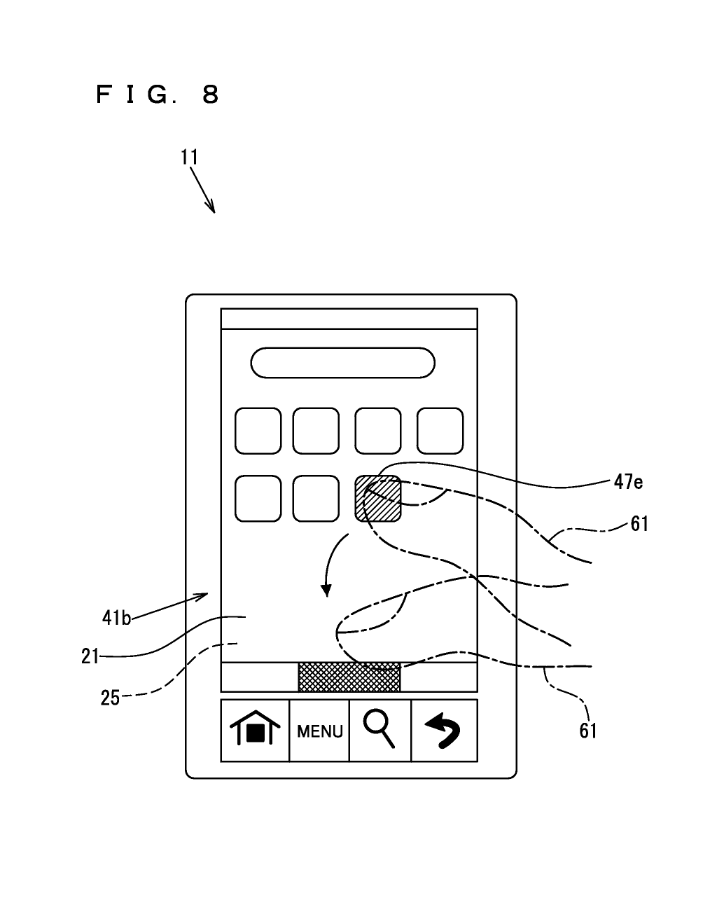

For example, when in the state shown in FIG. 6, the touch position of the finger 61 of the user transfers leftward, and departs from the right end of the screen, as shown in FIG. 7, the icon 47e transfers leftward on the second desktop screen 41b. When in the state shown in FIG. 7, as shown in FIG. 8, the flick operation is performed, steps S17 and S19 are executed, so that on the display module 21, the desktop screen 41a where the icon 47e is arranged (and highlighted) is displayed, as shown in FIG. 4.

If in step S17, it is not determined that the flick operation has been performed, the control module 13 determines whether or not the icon of the transfer object has been placed on another icon (S23). If it is determined the icon of the transfer object has been placed on the other icon, the control module 13 executes step S19 and subsequent steps.

If it is not determined that the icon of the transfer object has been placed on the other icon, the control module 13 determines whether or not the icon of the transfer object can be arranged on the desktop screen currently displayed (S25). For example, if in the icon arrangement zone 51 where the center of the icon of the transfer object is located, the other icon has been already arranged, it is determined that the icon cannot be arranged. Furthermore, if the same icon as the icon of the transfer object is arranged on the desktop screen currently displayed as well, it may be determined that the icon cannot be arranged.

If in step S25, it is determined that the icon can be arranged on the desktop screen, the control module 13 instructs the drawing module 17 to change the image data so as to contain the icon of the transfer object inside the icon arrangement zone 51 where the center of the relevant icon is located, and to update the setting information of the displayed desktop screen stored in the flash memory of the storage module 15 and add information regarding the type and the position of the added icon to the setting information (S27). Furthermore, the control module 13 deletes the information regarding the icon from the setting information of the desktop screen (of a transfer source) where the icon has been arranged. After step S27, the control module 13 ends the transfer processing of the icon.

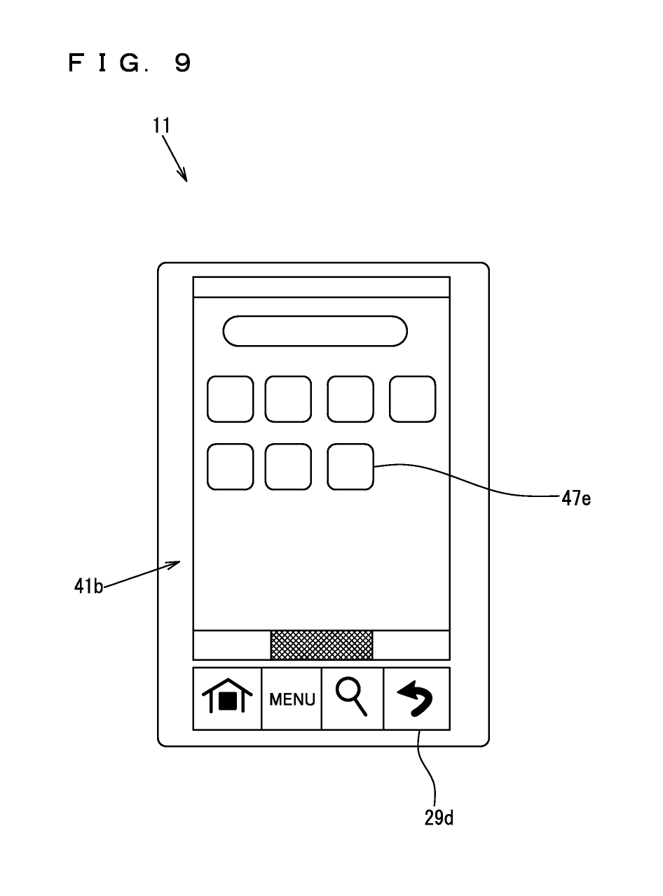

For example, if in the state shown in FIG. 7, the drop operation is performed, steps S23 to S27 are executed, so that on the display module 21, the desktop screen 41b to which the icon 47e has been added is displayed, as shown in FIG. 9. Moreover, the information regarding the icon 47e is deleted from the setting information of the desktop screen 41a shown in FIG. 2. Next time the desktop screen 41a is displayed on the display module 21, the icon 47e is not included in the desktop screen 41a.

While in the foregoing and FIG. 3, the icon 47e is specified by beforehand long-pressing the icon 47e in step S1 before the drag operation in step S3, step S1 may be omitted, and the icon 47e may directly be contacted to transfer the icon 47e by the drag operation as it is without the above-described specification operation of the icon. In this case, the control module 13 repeats the determination as to whether or not the drag operation has been performed, based on the touch position signal transmitted from the input control module 27 (Step S3).

Moreover, when step S1 is omitted, the processing in step S21 can also be omitted, and the control module 13 ends the transfer processing of the icon 47e after step S19.

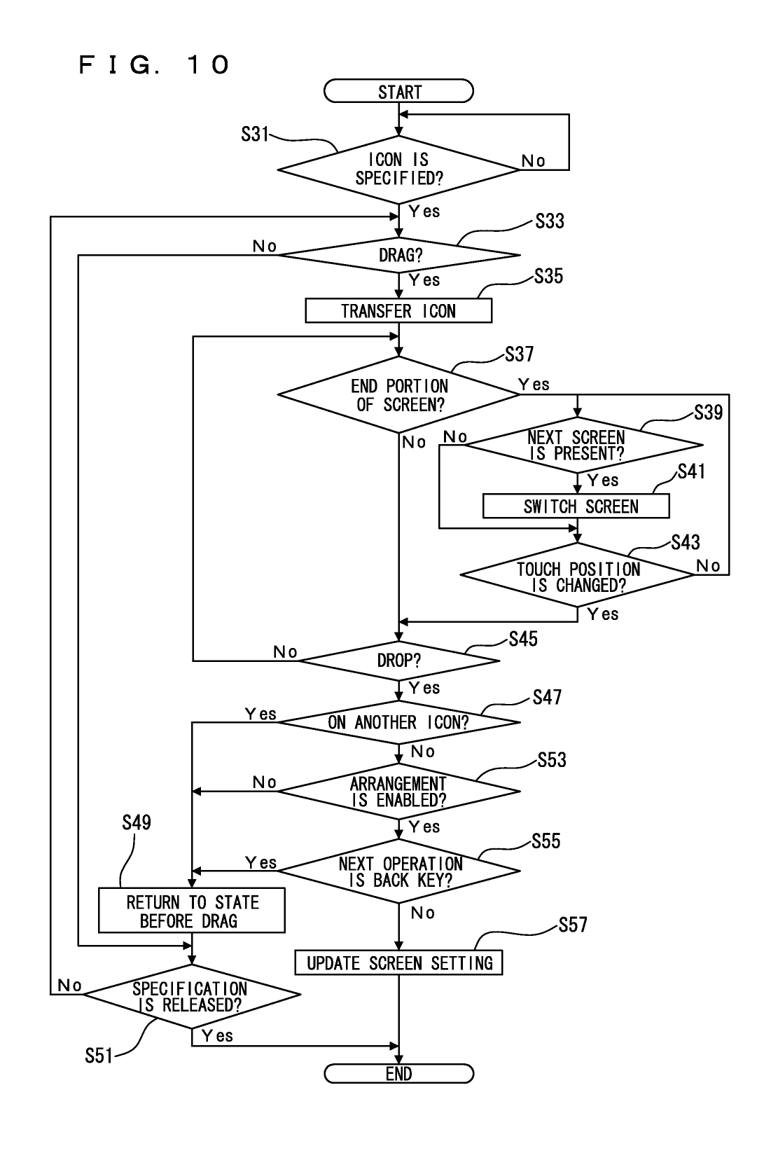

FIG. 10 is a flowchart showing a second embodiment of the transfer processing of the icon according to one example of the present invention. While in the first embodiment shown in FIG. 3, the transfer of the icon is cancelled by the flick operation on the touch panel 25, in the second embodiment, aback key 29d of the smartphone 11 is used.

Steps S31 to S45 shown in FIG. 10 correspond to steps S1 to S15 shown in FIG. 3, respectively. Step S47 corresponds to step S23 in FIG. 3. Steps S49 and S51 correspond to steps S19 and S21 in FIG. 3, respectively. Steps S53 and S57 correspond to steps S25 and S27 in FIG. 3, respectively.

In the second embodiment of the transfer processing of the icon, if in step S53, it is determined that the icon can be arranged on the desktop screen, the control module 13 determines whether or not first operation after drop operation in step S45 is a press of the back key 29d (S55). If it is determined that the first operation is the press of the back key 29d, the control module 13 executes step S49 and subsequent steps. If the first operation is not the press of the back key 29d, the control module 13 executes step S57 corresponding to step S27 in FIG. 3.

For example, if in step S53, it is determined that the icon can be arranged on the desktop screen, and the desktop screen 41b where the icon 47e is arranged is displayed on the display module 21, as shown in FIG. 9, pressing the back key 29d as the first operation after the drop operation causes the desktop screen 41a shown in FIG. 2 to be displayed. In this manner, the press of the back key 29d easily cancels the transfer of the icon 47e.

As described before, tapping the launcher 49 of the desktop screens 41a, 41b shown in FIGS. 2 and 9 causes the menu screen to be displayed on the display module 21. The menu screen provides a table or a list of the applications that the smartphone can execute, using the icons.

FIG. 11 shows how the menu screen 71 is displayed on the display module 21. In the menu screen 71, the status bar 43, a plurality of icons 73 and a scroll bar 75 are included. As shown in FIG. 11, on the display module 21, up to 20 of the icons 73 are shown. The icons 73 included in the menu screen 71 are scrolled by drag-operating the touch panel 25 so as to move up and down the scroll bar 75, so that combination of the icons 73 displayed on the display module 21 is changed.

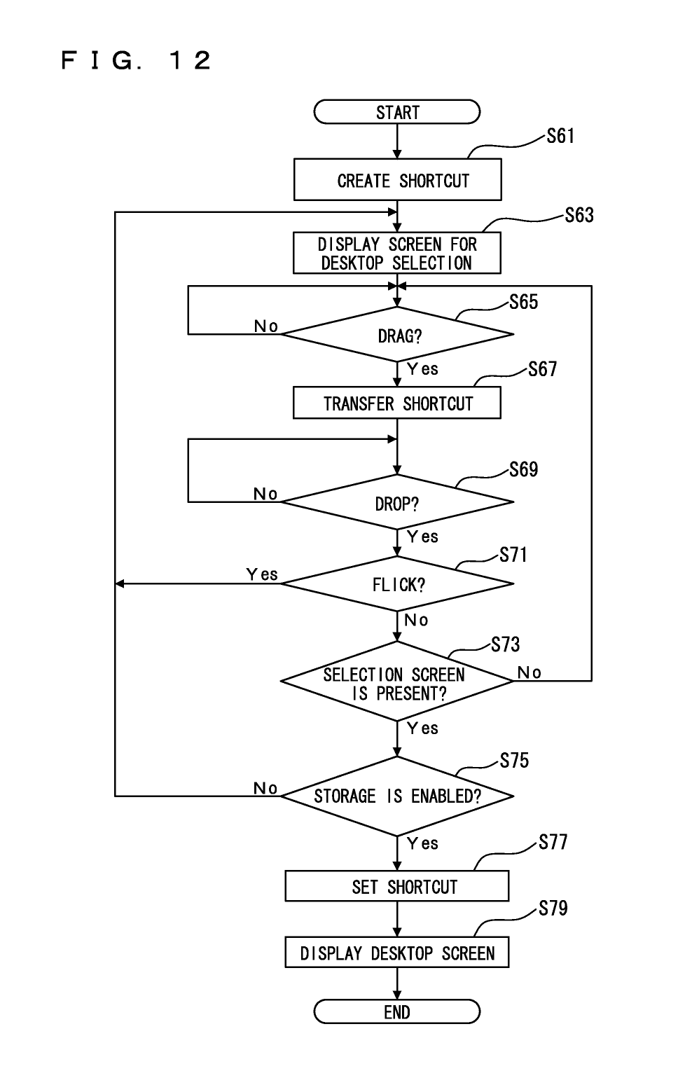

FIG. 12 is a flowchart showing setting processing of shortcut icons according to one example of the present invention. A program describing a procedure of this processing is stored in the ROM of the storage module 15, and is executed by the control module 13. First, when the touch panel 25 is long-pressed on the specific icon in the menu screen displayed on the display module 21, the control module 13 creates data of the shortcut icon of the icon to store the same in the storage module 15 (S61).

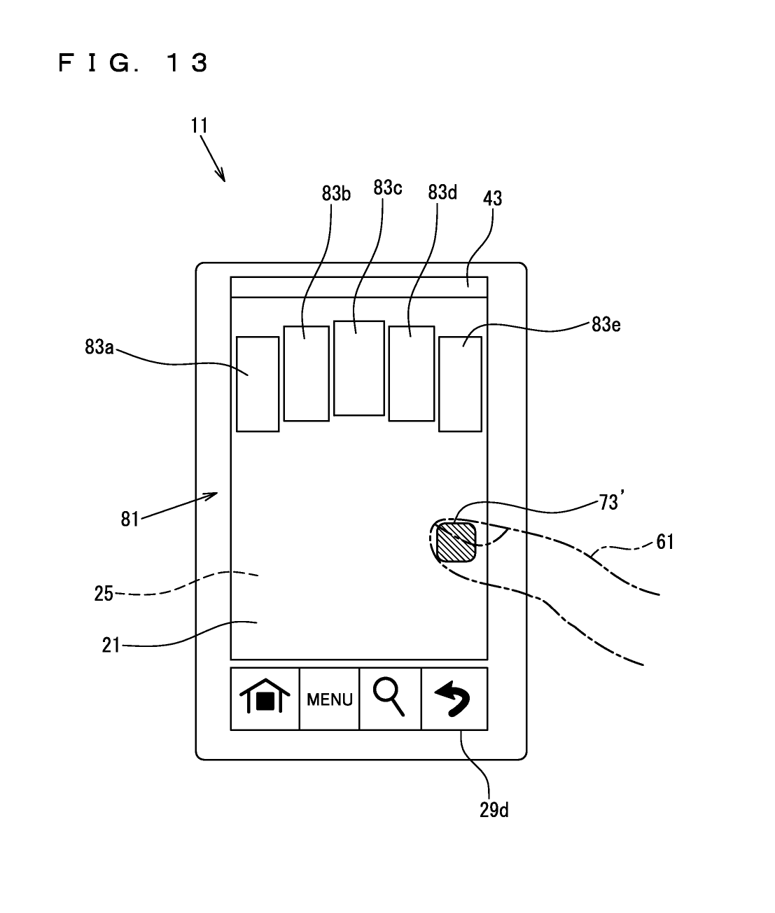

After step S61, the control module 13 instructs the drawing module 17 to display a screen for desktop selection together with the shortcut icon on the display module 21 (S63). The screen for desktop selection is used to set an operation screen where the shortcut icon is to be stored. For example, when in the state shown in FIG. 11, the second icon 73 from the bottom in a rightmost row included in the menu screen 71 is specified in step S61, a screen for desktop selection 81 shown in FIG. 13 is displayed together with a shortcut icon 73′ on the display module 21. When step S63 is executed and the screen for desktop selection is displayed on the display module 21, the shortcut icon 73′ is arranged at a position where a display surface of the display module 21 is long-pressed.

In the screen for desktop selection 81, the status bar 43, the shortcut icon 73′ and thumbnails 83a to 83e of the desktop screens are included. In the present example, the five thumbnails 83a to 83e correspond to the five desktop screens that can be set in the present example, respectively. For example, the central thumbnail 83c is a thumbnail, that is, a reduced image of the desktop screen 41a shown in FIG. 2. Each of the desktop screens is selected as a storage destination, when the shortcut icon 73′ is arranged on the corresponding one of the thumbnails 83a to 83e.

After step S63, the control module 13 determines whether or not the drag operation has been performed (S65). If in step S65, it is determined that the drag operation has been performed, the control module 13 transfers the shortcut icon on the screen for desktop selection as in step S5 in FIG. 3 (S67). After step S67, the control module 13 determines whether or not the drop operation has been performed (S69). If in step S69, it is determined that the drop operation has been performed, the control module 13 determines whether or not the flick operation has been performed (whether or not the drop operation has accompanied the flick operation) (S71).

If in step S71, it is not determined that the flick operation has been performed, the control module 13 determines whether or not the desktop screen selected as the storage destination of the shortcut icon is present (S73). If the selected desktop screen is present, the control module 13 determines whether or not the shortcut icon can be stored in the desktop screen (S75).

If in step S75, it is determined that the shortcut icon can be stored, the control module 13 updates the setting information of the selected desktop screen to store the shortcut icon (S77). The control module 13 displays the desktop screen including the created shortcut icon on the display module 21, based on the updated setting information (S79).

In step S75, for example, if the number of the icons included in the selected desktop screen has reached an upper limit value, or if the same shortcut icon has been already included, it is not determined that the shortcut icon can be stored. In this case, the control module 13 re-executes step S63. That is, the shortcut icon is returned to the position before the drag operation is performed.

If in step S71, it is determined that the flick operation has been performed, step S63 is also executed. This allows the user to easily stop or cancel the transfer of the shortcut icon in the setting processing of the shortcut icon by performing the flick operation, following the drag operation.

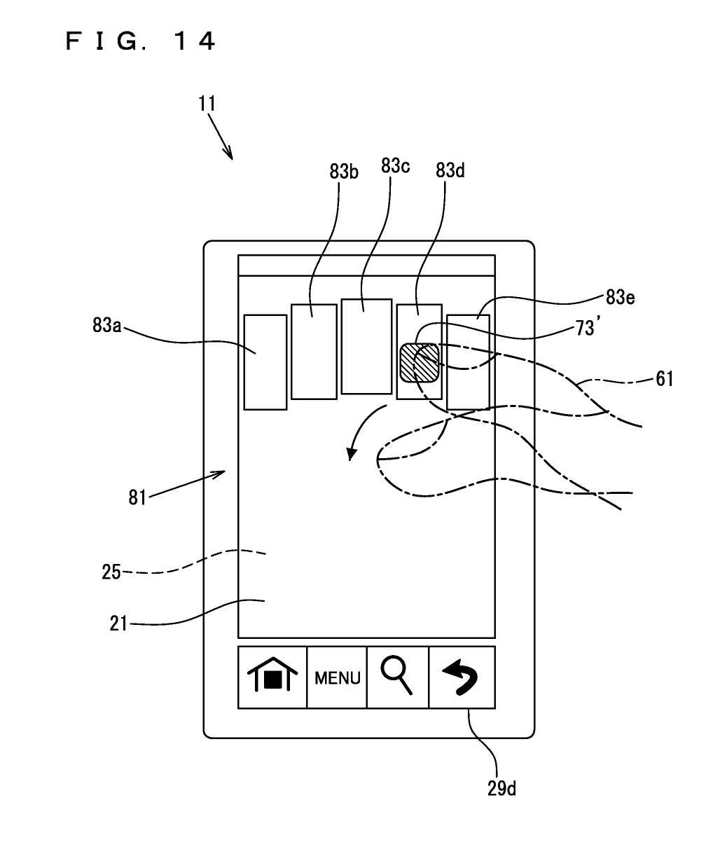

For example, although in the state shown in FIG. 13, the user performs the drag operation to arrange the shortcut icon 73′ on the thumbnail 83d on the desktop screen, the flick operation is performed during the drag operation, as shown in FIG. 14, by which step S63 is executed and the shortcut icon 73′ returns to the position shown in FIG. 13 without being set or stored on the desktop screen corresponding to the thumbnail 83d.

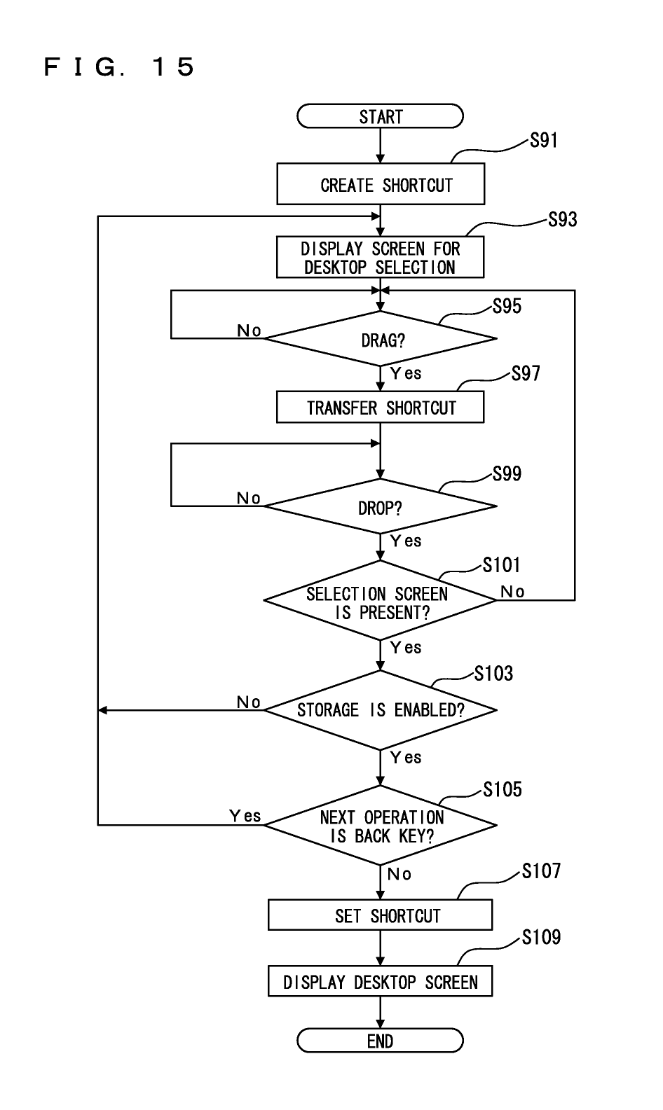

FIG. 15 is a flowchart showing a second embodiment of the setting processing of the shortcut icon according to one example of the present invention. While in the first embodiment shown in FIG. 12, the setting processing of the shortcut icon is stopped by the flick operation on the touch panel 25, in the second embodiment, the back key 29d of the smartphone 11 is used.

Steps S91 to S99 shown in FIG. 15 correspond to steps S61 to S69 shown in FIG. 12, respectively. Steps S101 and S103 correspond to steps S73 and S75 in FIG. 12, respectively. Steps S107 and S109 correspond to steps S77 and S79 in FIG. 12, respectively.

If in step S103, it is determined that the shortcut icon can be stored, the control module 13 determines whether or not first operation after the drop operation in step S99 is a press of the back key 29d (S105). If in step S105, it is determined that the first operation is not the press of the back key 29d, the control module 13 executes steps S107 and S109. If it is determined that the first operation is the press of the back key 29d, the control module 13 executes step S93, so that the shortcut icon is returned to the position before the drag operation is performed.

For example, although in the state shown in FIG. 13, the user performs the drag operation to arrange the shortcut icon 73′ on the thumbnail 83d on the desktop screen 81 as shown in FIG. 14, if the first operation after the drop operation, which is determined in step S99, is the press of the back key 29d, then step S111 is executed, so that the shortcut icon 73′ returns to the position shown in FIG. 13 without being set or stored on the desktop screen corresponding to the thumbnail 83d.

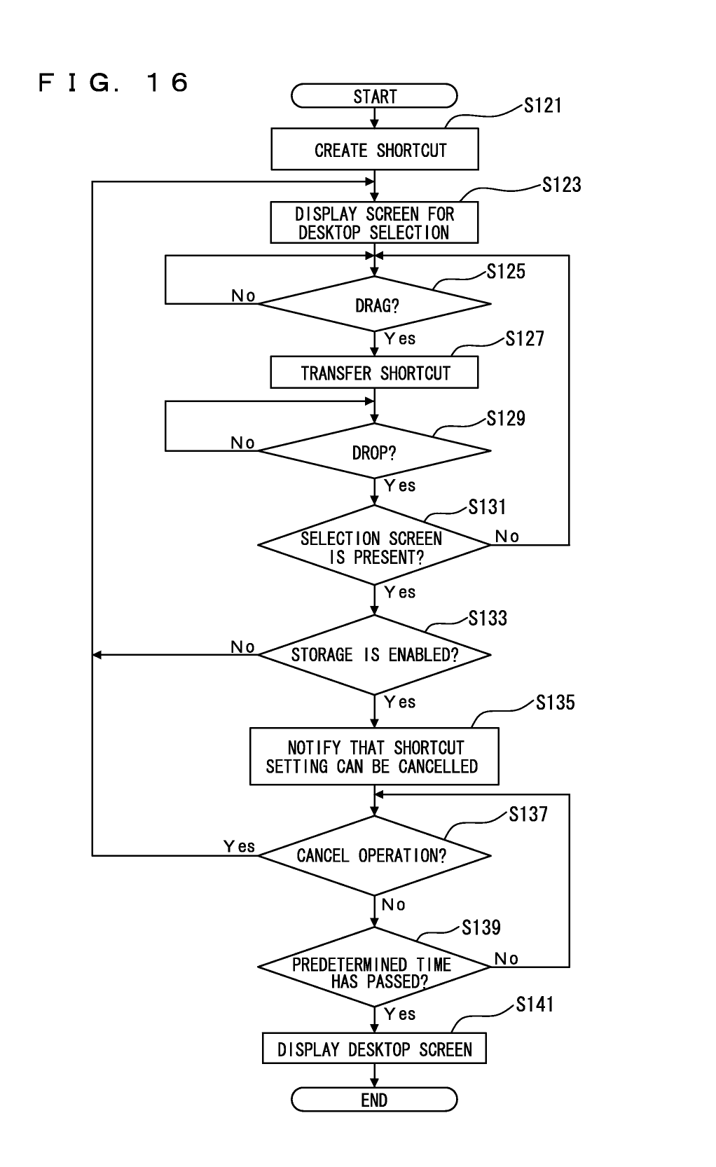

FIG. 16 is a flowchart showing a third embodiment of the setting processing of the shortcut icon according to one example of the present invention. Steps S121 to S133 shown in FIG. 16 correspond to steps S91 to S103 shown in FIG. 15, respectively. In the third embodiment shown in FIG. 16, if in step S133, it is determined that the shortcut icon can be stored, the control module 13 updates the setting information of the selected desktop screen to store the shortcut icon, and causes the display module 21 to display an image notifying that the setting of the shortcut icon can be cancelled (S135).

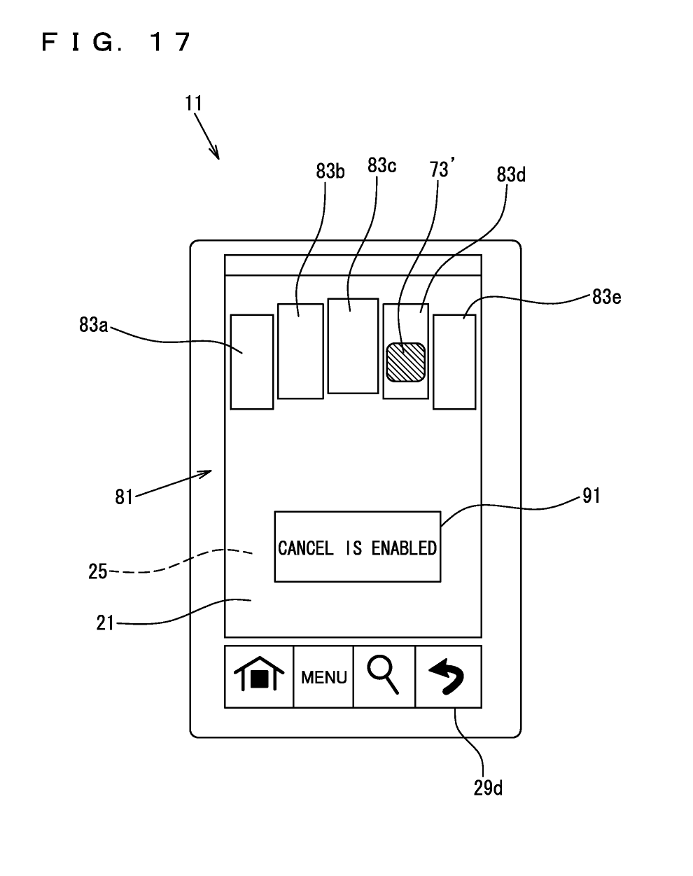

For example, after the shortcut icon 73′ is arranged on the thumbnail 83d of the desktop screen 81, as shown in FIG. 14, when steps S129 to S135 are executed, a notification image 91 is superimposed and displayed on the desktop screen 81, as shown in FIG. 17. The shortcut icon 73′ remains arranged on the thumbnail 83d of the desktop screen 81.

After step S135, the control module 13 determines whether or not operation of canceling the setting of the shortcut icon has been performed (S137). If in step S137, it is determined that cancel operation has been performed, step S123 is executed. For example, when in the state shown in FIG. 17, the cancel operation is performed, the shortcut icon 73′ returns to the position shown in FIG. 13 without being set or stored on the desktop screen corresponding to the thumbnail 83d.

The cancel operation may be operation on the touch panel 25, and for example, long-pressing the touch panel 25 on the shortcut icon 73′ or the notification image 91 may cause steps S137 and S123 to be executed. Moreover, the cancel operation may be operation of one of the hard keys 29a to 29d or another button provided in the smartphone 11, or a soft key or a button displayed on the display module 21. For example, pressing the back key 29d may cause steps S137 and S123 to be executed.

If in step S137, it is not determined that the cancel operation has been performed, the control module 13 determines whether or not predetermined time has passed since it has been determined in step S129 that the drop operation causing the execution of the step S135 has been performed (S139). In step S139, the control module 13 may determine whether or not predetermined time has passed since the notification image 91 has been displayed.

If in step S139, it is not determined that the predetermined time has passed, step S137 is re-executed. If in step S139, it is determined that the predetermined time has passed, step S141 similar to step S109 in FIG. 15 (step S79 in FIG. 12) is executed.

While the examples in which the present invention is applied to the smartphone have been described, the present invention can also be applied to an electronic device including a touch panel other than the smartphone, for example, a portable game machine, a navigation device, a printer and the like. The icons or the shortcuts processed according to the present invention may express, for example, document files, image files and the like. Moreover, the present invention may be applied to transfer of the widget and setting of the widget on the desktop screen.

The procedures shown in the flowcharts in FIGS. 3, 10, 12, 15 and 16 are merely the examples of the present invention, and the present invention may be carried out, using a procedure different from the procedures shown in these flowcharts.

While in the transfer processing of the icon shown in FIG. 3, the presence or absence of the flick operation is determined in step S17, the presence or absence of the long press (long touch) on the icon maybe determined. That is, when the icon is long-pressed, following the drag operation on the touch panel 25, the transfer of the icon is cancelled. Moreover, while in the setting processing of the shortcut icon shown in FIG. 12, the presence or absence of the flick operation is determined in step S71, the presence or absence of the long press on the shortcut icon maybe determined. That is, when the icon is long-pressed following the drag operation on the touch panel 25, the transfer of the icon is cancelled.

In the setting processing of the shortcut icon shown in FIG. 15, if the drop operation is performed in a state where the shortcut icon is not arranged on any of the thumbnails of the desktop screen 81, and none of the desktop screens is selected, step S93 maybe executed by pressing the back key 29d. Moreover, in the setting processing of the shortcut icon shown in FIG. 16 as well, if the cancel operation is performed in the state where the shortcut icon is not arranged on any of the thumbnails of the desktop screen 81, and none of the desktop screens is selected, step S123 may be executed.

In the setting processing of the shortcut icon shown in FIG. 12, 15 or FIG. 16, in place of re-executing step S63, the menu screen 71 in the state where step S61, S91 or S121 is executed maybe displayed on the display module 21.

The above description is to describe the present invention, and should not be construed as limiting or restricting the invention described in the scope of claims. Moreover, the configurations of the respective modules of the present invention are not limited to the above-described examples, and obviously, various modifications can be made within a technical range described in the scope of claims.

### DESCRIPTION OF REFERENCE CHARACTERS

11 smartphone
13 control module
15 storage module
21 display module
25 touch panel
29d back key
41a-b desktop screen
47a-k k icon
61 finger
71 menu screen
73 icon
73′ shortcut icon
81 menu screen
83a-e thumbnail
91 notification image

1. An electronic device comprising:
a display module;
a touch panel provided on a display surface of the display module; and
a control module configured to control display of the display module, wherein the display module displays an image to cause the electronic device to execute predetermined processing, and the control module transfers the image in accordance with an operation to the touch panel, and
when a predetermined operation is executed during the operation to the touch panel of transferring the image, the control module cancels the transfer of the image and causes the display module to display the image at a position before the transfer.

2. The electronic device according to claim 1, wherein the predetermined operation is an operation of inhibiting the image from being transferred from a predetermined area for predetermined time, or an operation of transferring the image at a predetermined speed or higher.

3. An electronic device comprising:
a display module;
a touch panel provided on a display surface of the display module; and
a control module configured to control display of the display module, wherein
the display module displays an image to cause the electronic device to execute predetermined processing, and the control module transfers the image in accordance with an operation to the touch panel, and
when a predetermined operation is executed by the electronic device before a predetermined time has passed since the operation to the touch panel of transferring the image has ended, the control module cancels the transfer of the image and causes the display module to display the image at a position before the transfer.

4. The electronic device according to claim 3, wherein when the operation to the touch panel of transferring the image ends, the control module causes the display module to display information indicating that the transfer of the image is capable to be cancelled until the predetermined time has passed or until the predetermined operation is executed.

5. The electronic device according to claim 1, wherein the image to cause the electronic device to execute the predetermined processing includes one or both of a shortcut icon and a widget.

6. The electronic device according to claim 3, wherein the predetermined operation is performed to the touch panel or to a key provided in the electronic device.

7. The electronic device according to claim 6, wherein the predetermined operation is an operation of touching the touch panel on the image for a predetermined time.

8. (canceled)

9. (canceled)

10. (canceled)

11. (canceled)
